(19) United States
(12) Patent Application Publication
(10) Pub. No.: US 2026/0229000 A1
(43) Pub. Date: Aug. 6, 2026

(54) METHOD AND ELECTRONIC DEVICE FOR IMPROVING VISUAL COMPOSITION OF AN IMAGE

(71) Applicant: SAMSUNG ELECTRONICS CO., LTD., Suwon-si (KR)

(72) Inventors: Pavan Sudheendra, Karnataka (IN); Sudha Velusamy, Karnataka (IN); Naresh Reddy Narem, Karnataka (IN); Girish Kulkarni, Karnataka (IN); Narayan Kothari, Karnataka (IN)

(73) Assignee: SAMSUNG ELECTRONICS CO., LTD., Suwon-si (KR)

(21) Appl. No.: 19/214,850

(22) Filed: May 21, 2025

Related U.S. Application Data
(63) Continuation of application No. PCT/KR2025/006013, filed on May 2, 2025.

(30) Foreign Application Priority Data
Feb. 6, 2025 (IN) 202541009754

(51) Int. Cl. G06V 10/25; G06T 7/12; G06T 7/50; G06T 7/70; G06T 7/90; G06V 10/426; G06V 10/44

(52) U.S. Cl. CPC G06V 10/25; G06T 7/12; G06T 7/50; G06T 7/70; G06T 7/90; G06V 10/426; G06V 10/44

(57) ABSTRACT

A method may be provided for modifying an image. The method may include obtaining, from one or more sources, an input image and metadata associated with the input image. The method may include obtaining, using an Artificial Intelligence (AI) model, a scene graph indicating a relationship between one or more visual features associated with the input image based on the metadata. The method may include predicting, using the AI model, one or more candidate probable missing elements based on the scene graph. The method may include determining a first candidate element having a probability score greater than a reference value, from the one or more candidate probable missing elements. The method may include determining, using the AI model, a region of interest (ROI) in the input image corresponding to the first candidate element. The method may include obtaining an output image by integrating an image corresponding to the first candidate element at the ROI.

### CROSS-REFERENCE TO RELATED APPLICATIONS

This application is a bypass continuation application of International Application No. PCT/KR2025/006013, filed on May 2, 2025, which is based on and claims priority under 35 U.S.C. § 119 to Indian Patent Application No. 202541009754 filed on Feb. 6, 2025, the disclosures of which are incorporated herein by reference in their entireties.

### BACKGROUND

### 1. Field

The disclosure relates to a method of image editing, and more particularly, to a method for improving visual composition of the image.

### 2. Description of Related Art

A context-rich image (or a context-rich photograph) is an image that contains a lot of visual information, tells a story or conveys a message beyond a simple image captured. The context-rich images often include factors such as composition, lighting, visual elements, action cues, relationships, and the like. These factors work together to create a visually appealing image that attracts and engages viewers. The content-rich images play a big role in social media attention, advertising, and fine art photography to convey specific ideas or emotions to the viewer. However, manual intervention of a user and expertise is generally required in preparing an output image, which may not only be considered time-consuming and tedious, but may not provide an optimal output image.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

According to an embodiment of the disclosure, a method may include obtaining, from one or more sources, an input image and metadata associated with the input image. The method may include obtaining, using an Artificial Intelligence (AI) model, a scene graph indicating a relationship between one or more visual features associated with the input image based on the metadata. The method may include predicting, using the AI model, one or more candidate probable missing elements based on the scene graph. The method may include determining a first candidate element having a probability score greater than a reference value, from the one or more candidate probable missing elements. The method may include determining, using the AI model, a region of interest (ROI) in the input image corresponding to the first candidate element. The method may include obtaining an output image by integrating an image corresponding to the first candidate element at the ROI.

According to an embodiment of the disclosure, an electronic device may include memory configured to store at least one instruction. The electronic device may include at least one processor, wherein, when executed by the at least one processor individually or collectively, the at least one instruction may be configured to control the electronic device to obtain, from one or more sources, an input image and metadata associated with the input image. The at least one instruction may be configured to control the electronic device to obtain, using an Artificial Intelligence (AI) model, a scene graph indicating a relationship between one or more visual features associated with the input image based on the metadata. The at least one instruction may be configured to control the electronic device to predict, using the AI model, one or more candidate probable missing elements based on the scene graph. The at least one instruction may be configured to control the electronic device to determine a first candidate element having a probability score greater than a reference value, from the one or more candidate probable missing elements. The at least one instruction may be configured to control the electronic device to determine, using the AI model, a region of interest (ROI) in the input image corresponding to the first candidate element. The at least one instruction may be configured to control the electronic device to obtain an output image by integrating an image corresponding to the first candidate element at the ROI.

According to an embodiment of the disclosure, a non-transitory computer-readable storage medium configured to store at least one instruction, which, when executed by at least one processor individually or collectively, may cause the at least one processor to obtain, from one or more sources, an input image and metadata associated with the input image. The at least one instruction, which, when executed by at least one processor individually or collectively, may the at least one processor to obtain, using an Artificial Intelligence (AI) model, a scene graph indicating a relationship between one or more visual features associated with the input image based on the metadata. The at least one instruction, which, when executed by at least one processor individually or collectively, may cause the at least one processor to predict, using the AI model, one or more candidate probable missing elements based on the scene graph. The at least one instruction, which, when executed by at least one processor individually or collectively, may cause the at least one processor to determine a first candidate element having a probability score greater than a reference value, from the one or more candidate probable missing elements. The at least one instruction, which, when executed by at least one processor individually or collectively, may cause the at least one processor to determine, using the AI model, a region of interest (ROI) in the input image corresponding to the first candidate element. The at least one instruction, which, when executed by at least one processor individually or collectively, may cause the at least one processor to obtain an output image by integrating an image corresponding to the first candidate element at the ROI.

### BRIEF DESCRIPTION OF DRAWINGS

The above and other aspects, features, and advantages of an embodiment of the present disclosure will be more apparent from the following description taken in conjunction with the accompanying drawings, in which:

FIG. 1 illustrates an exemplary environment 100 according to an embodiment of the present disclosure;

FIG. 2 illustrates an electronic device for improving visual composition of an image according to an embodiment of the present disclosure;

FIG. 3 illustrates an exemplary scene for generating of a scene graph from an input image according to an embodiment of the present disclosure;

FIG. 4 illustrates an exemplary scenario for determining a probability score of a plurality of missing elements according to an embodiment of the present disclosure;

FIG. 5 illustrates an exemplary depth map of the input image according to an embodiment of the present disclosure;

FIGS. 6A-6F illustrate exemplary depictions of determining a size of at least one missing element according to an embodiment of the present disclosure;

FIG. 7 illustrates an exemplary segmentation map of the input image according to an embodiment of the present disclosure;

FIGS. 8A-8C illustrates exemplary depictions of determining a plurality of Regions of Interest (ROIs) according to an embodiment of the present disclosure;

FIG. 9 illustrates exemplary depictions of determining an optimal ROI according to an embodiment of the present disclosure;

FIGS. 10A and 10B illustrate exemplary depictions of improving visual composition of the input image according to an embodiment of the present disclosure;

FIG. 11 illustrates a flow chart of a method of improving visual composition of the image according to an embodiment of the present disclosure; and

FIG. 12 illustrates a block diagram of an exemplary computer system according to an embodiment of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown. It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

### DETAILED DESCRIPTION

Embodiments and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The terms “comprises”, “comprising”, or any other variations thereof, are intended to cover a non-exclusive inclusion, such that a setup, device or method that comprises a list of components or operations does not include only those components or operations but may include other components or operations not expressly listed or inherent to such setup or device or method. In other words, one or more elements in a system or apparatus proceeded by “comprises . . . a” does not, without more constraints, preclude the existence of other elements or additional elements in the system or apparatus.

As is traditional in the field, embodiments may be described and illustrated in terms of blocks which carry out a described function or functions. These blocks, which may be referred to herein as managers, units, modules, hardware components, terms ending with “~or” (e.g., “generator”), terms ending with “~er” or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It is to be understood that the singular forms “a,” “an,” and “the” include plural referents unless the context clearly dictates otherwise. Thus, for example, reference to “a component surface” includes reference to one or more of such surfaces.

Any of the functions or operations described herein can be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like. An embodiment of the present disclosure may provide a method and an electronic device for improving visual composition of an image. According to an embodiment of the present disclosure, an input image and metadata associated with the input image may be obtained from one or more sources. An Artificial Intelligence (AI) model may determine at least one missing element in the input image and generate an output image by including the at least one missing element at a Region of Interest (ROI) in the input image, thereby improving the visual composition of the input image.

An embodiment of the present disclosure is hereinafter explained with reference to the drawings.

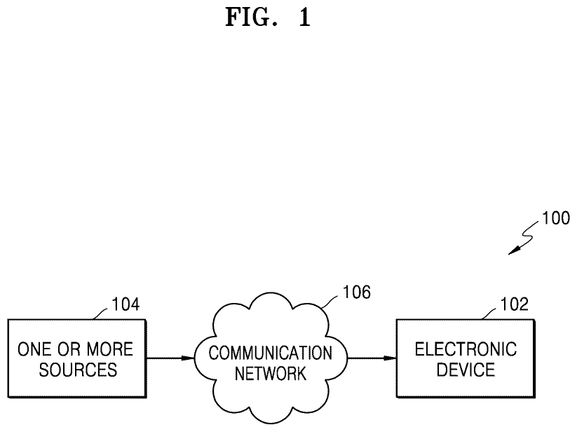

FIG. 1 illustrates an exemplary environment 100 according to an embodiment of the present disclosure. The exemplary environment 100 may include an electronic device 102, one or more sources 104 and a communication network 106. The electronic device may be a User Equipment (UE). Some examples of the electronic device 102 may include, but not limited to, electronic devices such as, a smartphone, a laptop, a desktop, a personal computer, or any spatial computing device capable of displaying images. For example, the electronic device 102 may work on multiple platforms and/or Operating Systems (OS). The electronic device 102 may establish a communication with the one or more sources 104. For example, the electronic device 102 may establish a communication with the one or more sources 104 to obtain input images and metadata. The metadata may include data associated with the input images. For example, the metadata may include, but is not limited to, location, season, time and weather.

According to an embodiment, the electronic device 102 may generate an output image by improving the visual composition of the input image. For example, upon receiving the input image from the one or more sources 104, the electronic device 102 may generate an output image by improving the visual composition of the input image. The one or more sources 104 may include one or more electronic devices. For example, the one or more sources 104 may include, but is not limited to, an image database, an external camera, a camera associated with the electronic device 102, and the like. In an example case in which the output image with improved visual composition of the input image is to be generated, the one or more sources 104 may be deployed at a remote location and may access the electronic device 102. According to an embodiment, the one or more sources 104 may be deployed within the electronic device 102. However, the disclosure is not limited thereto, and as such, according to an embodiment, the one or more sources 104 may be operatively coupled to the electronic device 102, and the like.

According to an embodiment, the electronic device 102 may establish a connection with the one or more sources 104 via a communication network 106. According to an embodiment, the electronic device 102 may be in operative communication with the communication network 106, such as the Internet, enabled by a network provider, also known as an Internet Service Provider (ISP). The electronic device 102 may be connected to the communication network 106 using a wireless network. For example, the wireless network may include, but is not limited to, the Wireless LAN (WLAN), cellular networks, Bluetooth or ZigBee networks, and the like.

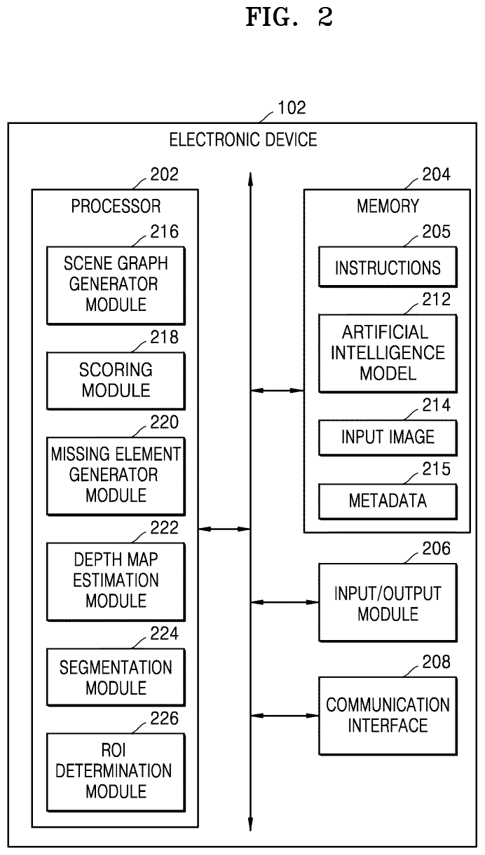

According to an embodiment of the disclosure, there may be provided a method performed by the electronic device 102 for improving visual composition of the input image obtained from the one or more sources 104. The operations performed by the electronic device 102 are explained in detail next with reference to FIG. 2.

FIG. 2 illustrates an electronic device 102 for improving visual composition of an image according to an embodiment of the present disclosure. For example, the electronic device 102 may establish a connection with the one or more sources 104 to obtain the input image and the metadata for generating visually improved output image.

The electronic device 102 may include a processor 202, a memory 204, an Input/Output (I/O) module 206, and a communication interface 208. According to an embodiment, the electronic device 102 may include more or fewer components than those depicted in FIG. 2. For example, the various components of the electronic device 102 may be implemented using hardware, software, firmware, or any combinations thereof. For example, the various components of the electronic device 102 may be operably coupled with each other. For example, various components of the electronic device 102 may be capable of communicating with each other using communication channel media (such as buses, interconnects, etc.). The processor 202 may include at least one data processor for executing program components for executing user or system-generated requests. The memory 204 may be communicatively coupled to the processor 202. The memory 204 may store at least one instruction 205, executable by the processor 202, which, on execution, may cause the processor 202 to generate visually improved output image.

In one embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like. The processor 202 may include, but not limited to, a scene graph generator module 216, a scoring module 218, a missing element generator module 220, depth map estimation module 222, segmentation module 224 and a Region of Interest (ROI) determination module 226. According to an embodiment, one or more modules may be implemented by the processor 202 executing one or more software code, programs or instructions stored in memory or a storage.

The processor 202 may write data to the memory 204 or read data stored in the memory 204. In particular, the processor 202 may process data according to defined operation rules or an artificial intelligence (AI) model by executing a program or at least one instruction 205 stored in the memory 204. Accordingly, the processor 202 may perform operations described in the following embodiments, and unless otherwise specified, operations described as being performed by the electronic device 102 or by components included in the electronic device 102 may be understood as being performed by the processor 202.

The memory 204 may be a component configured to store various programs or data, and may include a storage medium such as a read-only memory (ROM), random access memory (RAM), hard disk, CD-ROM, DVD, or a combination of such storage media. The memory 204 may not be implemented as a separate component but may be integrated into the processor 202. The memory 204 may include volatile memory, non-volatile memory, or a combination of volatile and non-volatile memory. A program or at least one instruction 205 for performing operations according to the embodiments described below may be stored in the memory 204. The memory 204 may also provide the stored data to the processor 202 in response to a request from the processor 202.

The processor 202 may obtain the input image and the metadata from the one or more sources 104. The metadata may include data associated with, but not limited to, location, season, time and weather corresponding to the input image. According to an embodiment, the processor 202 may access the input image and the metadata from the memory 204. For example, the input data may be stored as input image 214 and the metadata may be stored as metadata 215.

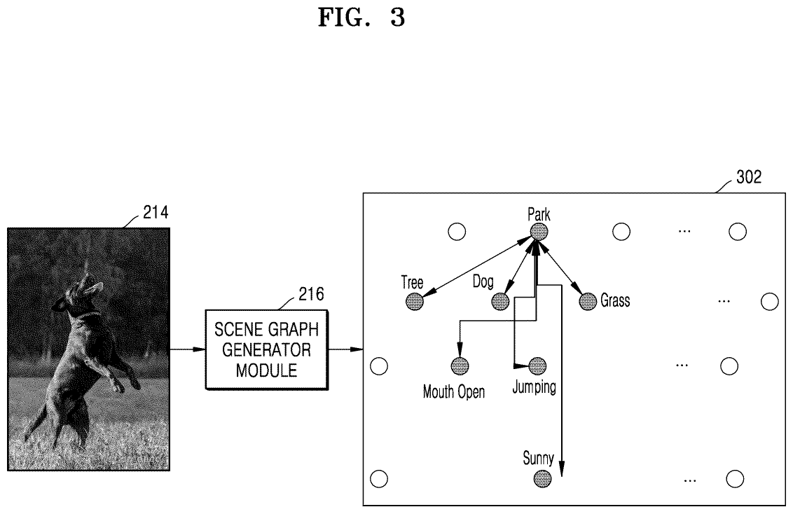

The scene graph generator module 216, in conjunction with an Artificial Intelligence (AI) model 212 stored in the memory 204, may generate a scene graph indicating a relationship between one or more visual features associated with the input image 214 based on the metadata 215. According to an embodiment, contextual information associated with the input image 214 may be determined. The contextual information may include at least one of: the one or more visual features in the input image 214, visual attributes associated with each of the one or more visual features, and a relationship between the one or more visual features. For example, FIG. 3 illustrates generating a scene graph 302 from the input image 214 according to an embodiment of the present disclosure. In an embodiment shown in FIG. 3, the input image 214 may be an image of a dog jumping in a park. The scene graph generator module 216 identifies the one or more visual features (e.g., contextual information from the input image 214), such as, park, dog, tree, grass, mouth open, jumping, sunny, and the like. The scene graph generator module 216, in conjunction with the AI model 212, may identify the relationship between park, dog, tree, grass, mouth open, jumping, sunny, and the like. The AI model 212 may be trained using large data comprising various images in different environments. For example, the AI model 212 may be trained to identify the one or more visual features, and the relationship between them. According to an embodiment, a Region-based Convolutional Neural Networks (R-CNN) may be used to identify the one or more visual features, and the relationship between them from the input image 214. According to an embodiment, a Recurrent Neural Networks (RNN) may be used to generate the scene graph 302 based on the one or more identified visual features, and the relationship between them. According to an embodiment, the scene graph 302 may be generated such that the one or more visual features are depicted as nodes, and the relationship between them is depicted as edges.

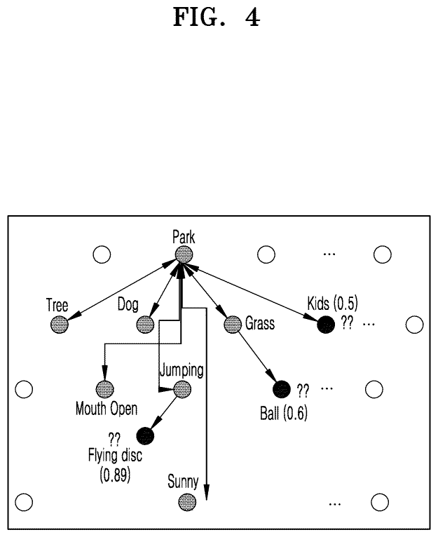

Referring to FIG. 2, the missing element generator module 220, in conjunction with the AI model 212, may predict one or more candidate probable missing elements based on at least one of: the scene graph, the one or more visual features, the input image 214 and the metadata 215. For example, the candidate elements may be probably missing elements or potentially missing elements. For example, since the AI model 212 may be trained using the large data comprising various images in different environments, the AI model 212 may identify the probable missing elements in the input image 214. According to an embodiment, a Graph Convolution Network (GCN) may be used to predict the one or more candidate probable missing elements. According to an embodiment, a classifier module and a cross-entropy loss may be used to train the AI model 212. According to an embodiment, the AI model 212 may predict the one or more probable missing elements based on the input image 214 alone. For example, FIG. 4 illustrates a method of determining a probability score of one or more probable missing elements according to an embodiment of the present disclosure. Referring to FIGS. 3 and 4, in an example case in which the input image 214 is a dog jumping in a park, a candidate element or a probable missing element may be a ball. For example, the ball may be determined as the candidate element or the probable missing element, from among one or more probable missing elements based on the input image 214. The ball may be predicted based on the dog and jumping. In an example case, a probable missing element from the one or more probable missing elements based on the metadata 215 may be a flying disc (e.g., Frisbee®). The flying disc may be predicted based on the location, dog and weather. In an example case, a probable missing element from the one or more probable missing elements based on the one or more visual features may be kids. For example, since the one or more visual features depicts a park, the AI model 212 may predict that kids may be the probable missing element.

Referring to FIG. 2, the scoring module 218, in conjunction with the AI model 212, may assign a probability score corresponding to each of the one or more candidate elements (e.g., the probable missing elements) based on a relationship between each of the one or more candidate elements and the one or more visual features. According to an embodiment, the scoring module 218 may determine the probability score based on the probability of the corresponding candidate element (e.g., the corresponding probable missing element) being the missing element. According to an embodiment, the AI model 212 may be trained based on, but not limited to, Region-based Convolutional Neural Networks (R-CNN) and Recurrent Neural Networks (RNN) to identify contextual information in the one or more visual features and identify relationship between the one or more visual features. For example, FIG. 4 depicts the one or more candidate elements and their corresponding probability score. In an embodiment, the AI model 212 may consider the one or more visual features to determine the probability score. For example, the AI model 212 may consider the one or more visual features to be the dog jumping, which looks like dog may be catching an object. Thus, the AI model 212 may determine that the probability score of the flying disc to improve the visual effect of the input image 214 is 0.89. On the other hand, kids may just function as background and may not actively improve the visual composition. Therefore, the probability score of the kids may be 0.5. The scoring module 218 may determine at least one missing element having a probability score above a reference value. For example, the reference value may be a predefined threshold score. In an example case in which the predefined threshold score is 0.7, the at least one missing element may be determined to be the flying disc, which as a probability score of 0.89. According to an embodiment, characteristics of the at least one missing element may be based on the input image 214. For example, the input image 214 is of the dog jumping in a park with mouth open and the at least one missing element is the flying disc. The AI model 212, based on one or more characteristics of the input image 214, may determine the characteristics of the at least one missing element. The characteristics of the at least one missing element may be such as, but not limited to, at least one of: a color, an action and an orientation. For example, the AI model 212 may determine that the flying disc should be orange in color to contrast with the green color of the trees and the grass, thus improving the visual composition.

Referring to FIG. 2, the ROI determination module 226, in conjunction with the AI model 212, may determine an optimal ROI corresponding to the at least one missing element. The optimal ROI may be identified based on at least one of a depth map and a segmentation map of the input image 214, for the at least one missing element.

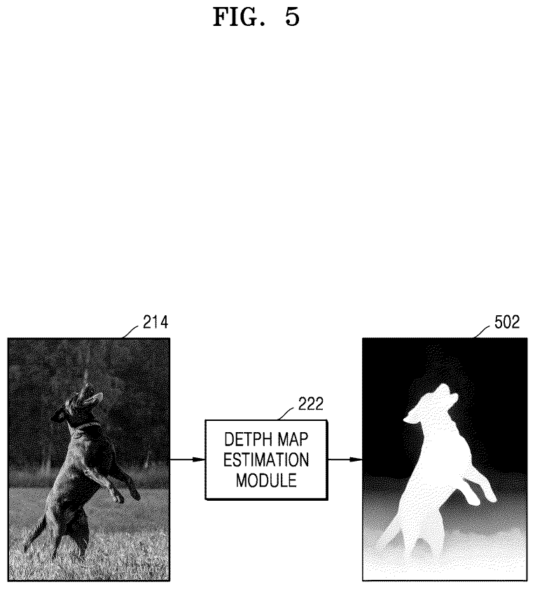

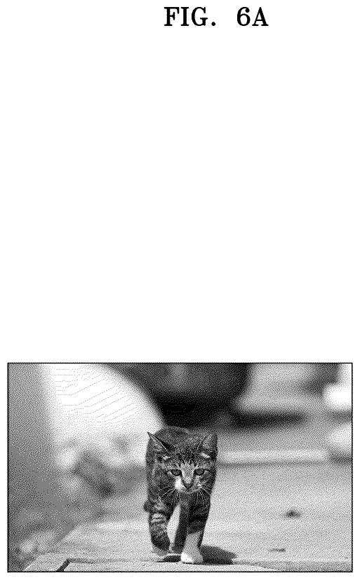

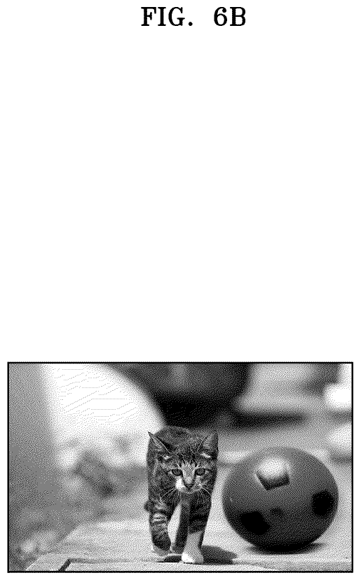

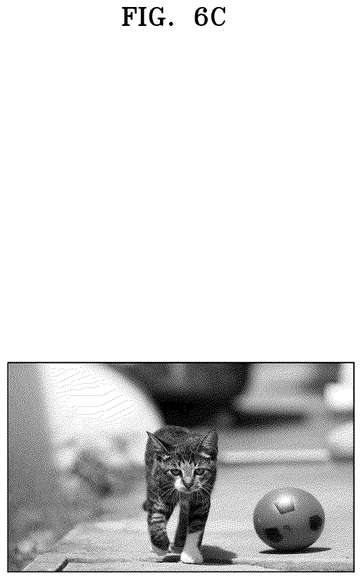

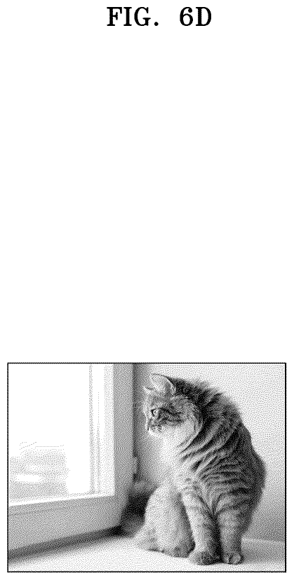

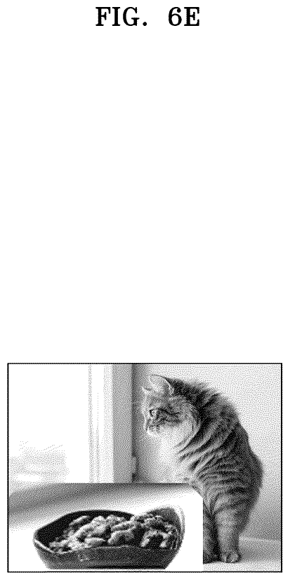

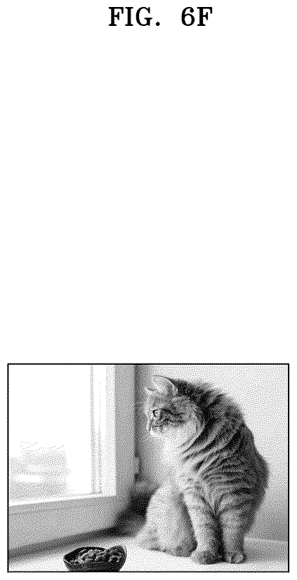

The depth estimation module 222 may generate a depth map of the input image 214. The at least one missing element may be placed at the optimal ROI. FIG. 5 illustrates a depth map 502 of the input image 214 according to an embodiment of the present disclosure. The depth map 502 may serve as a vital reference point for estimating the optimal ROI. For example, a scale and a size of the at least one missing element may be determined based on the depth map 502. According to an embodiment, the AI model 212 may be trained based on self-Distillation with NO labels (DINOv2) architecture to generate the depth map 502. For example, FIGS. 6A-6F illustrate exemplary depictions of determining a size of at least one missing element according to an embodiment of the present disclosure. FIG. 6A illustrates an example case in which the input image depicts a cat walking on a street. FIGS. 6B and 6C depict an image of the cat walking on the street with improved visual composition. In an example case illustrated in FIGS. 6A-6C, the at least one missing element is a ball. In an embodiment, the AI model 212 may determine the size of at least one missing element based on the depth map. The AI model 212 may determine a size of the ball to be shown in image depicted in FIG. 6B. However, as shown in FIG. 6B, the size of the ball is too big in relation to the cat, which may make the image less visually appealing than an image including a ball of an appropriate size. Therefore, the addition of the missing element (e.g., the ball) of FIG. 6B may not improve the visual composition of the input image in FIG. 6A. However, the size of the ball in the image shown in FIG. 6C depicts the improvement of the visual composition of the input image in FIG. 6A. According to an embodiment, the AI model 212 may be trained such that based on the depth map 502, the AI model 212 determines the size of the at least one missing element, however it is not limited thereto. In an embodiment illustrated in FIG. 6C, the AI model 212 may determine the size of the ball based on the size of the cat. Similarly, in an example case illustrated in FIG. 6D, the input image depicts a cat sitting near a window. An image in FIG. 6E depicts the cat sitting near the window with a bowl of food. However, the size of the bowl of food is too big in relation to the cat. Therefore, the image in FIG. 6E may not be visually appealing and may not enhance the visual composition of the input image in FIG. 6D. An image in FIG. 6F depicts an image of the cat sitting near a window with the bowl of food. In the image depicted in FIG. 6F, the size of the bowl of food is of an appropriate size in relation to the cat. Therefore, image in FIG. 6F may be an improved visual composition of the input image in FIG. 6D of the cat sitting near the window.

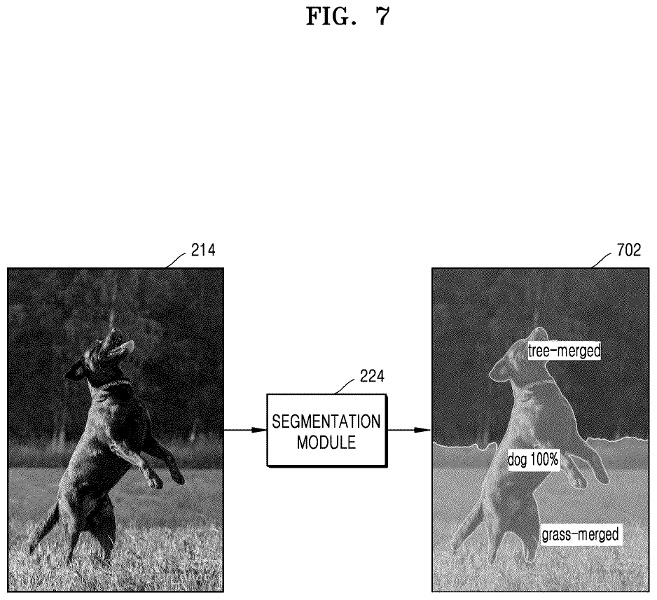

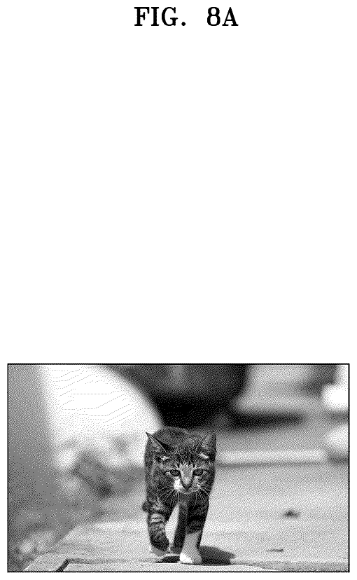

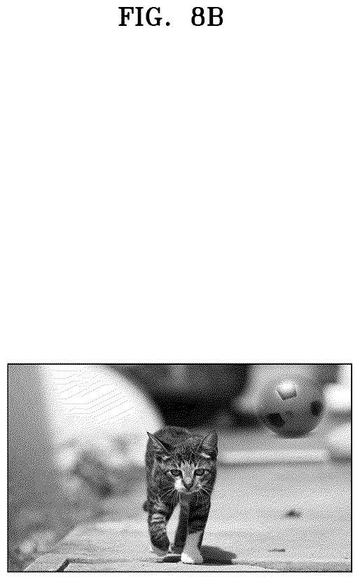

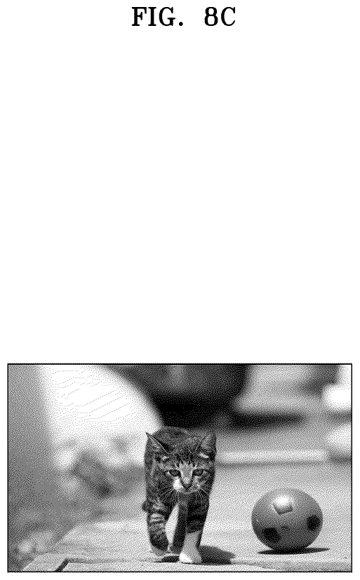

Referring to FIG. 2, the segmentation module 224 may generate a segmentation map of the input image 214. For example, FIG. 7 illustrates a segmentation map 702 of an input image 214 according to an embodiment of the present disclosure. According to an embodiment, the AI model 212 may be trained based on Mask2Former image segmentation architecture to identify the segmentation map 702. The Mask2Former is a universal architecture that can be used for, but not limited to, semantic segmentation, panoptic segmentation, and instance segmentation. According to an embodiment, the segmentation map 702 may be used to determine the optimal ROI. For example, FIGS. 8A-8C illustrate exemplary depiction of determining an optimal Region of Interest (ROI) corresponding to at least one missing element according to an embodiment of the present disclosure. For example, FIGS. 8A-8C illustrate determining the optimal ROI for inserting the at least one missing element (e.g., the ball) into the input image. For example, the at least one missing element (e.g., the ball) may be positioned as depicted in images in FIG. 8B or 8C based on the input image in FIG. 8A (which is same as image in FIG. 6A). However, the image shown in FIG. 8C may be more visually appealing and may look like the cat is playing with the ball. However, in the image shown in FIG. 8B, it may look like the ball is in the air. In an example, the ROI determination module 226, in conjunction with the AI model 212, and based on the segmentation map and the depth map, may determine that the depiction of the image in FIG. 8C improves the visual composition of the input image in FIG. 8A more than the depiction of the image in FIG. 8B, therefore the ROI depicted in the image in FIG. 8C may be determined to be the optimal ROI.

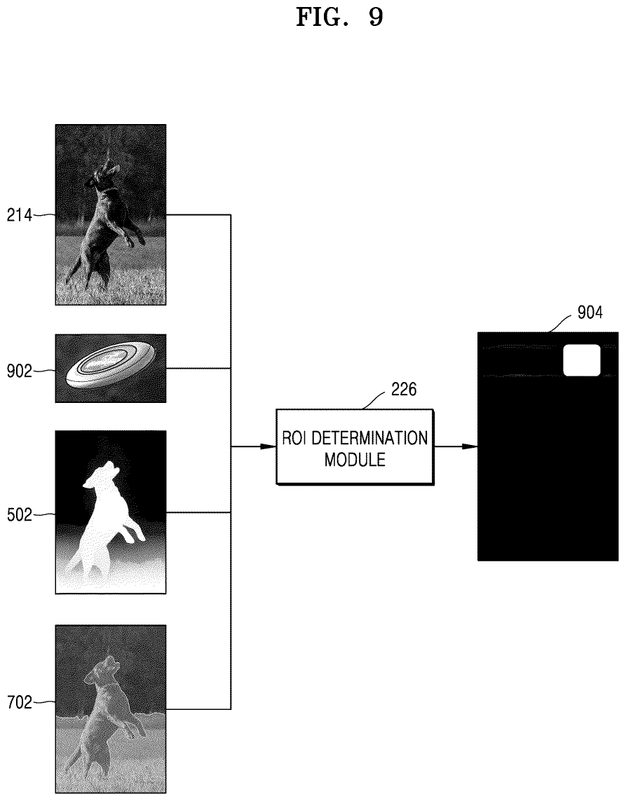

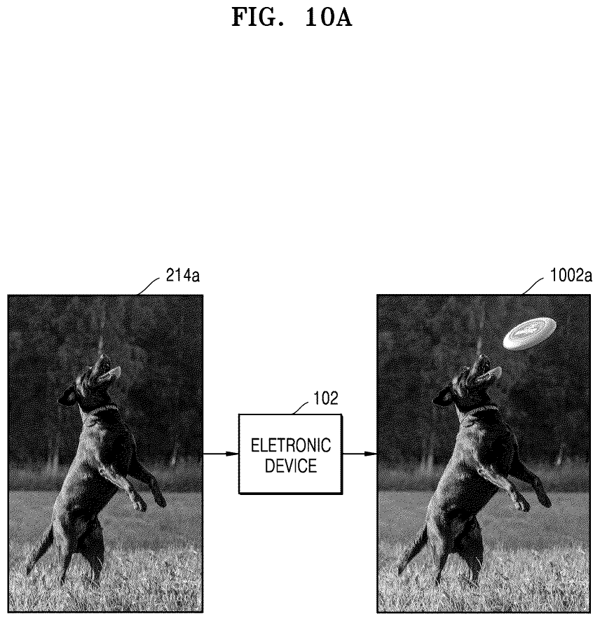

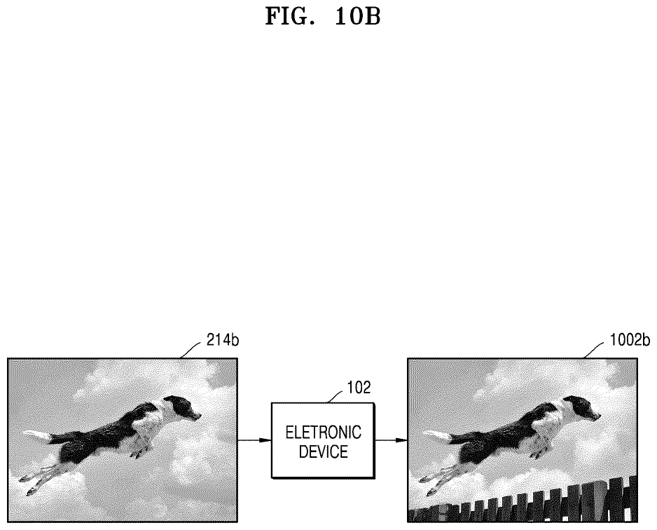

Referring to FIG. 2, in an embodiment, based on the depth map and the segmentation map, the ROI determination module 226, in conjunction with the AI model 212, may determine an optimal ROI where the at least one missing element can be placed to improve the visual composition of the input image 214. For example, FIG. 9 illustrates exemplary depictions of determining an optimal ROI according to an embodiment of the present disclosure. In an example, the segmentation map 702 from the segmentation module 224, the depth map 502 from the depth map estimation module 222, at least one missing element 902 (for instance, the flying disc) and an input image 214 may be provided to the ROI determination module 226. According to an embodiment, a text prompt comprising information of the at least one missing element 902 and one or more characteristics of the at least one missing element 902 may be provided to the ROI determination module 226 with the segmentation map 702 and the depth map 502. The ROI determination module 226 may determine the best position for the at least one missing element 902 (e.g., the flying disc) to be inserted in the input image 214 of the dog jumping in a park with mouth open. The ROI determination module 226, in conjunction with the AI model 212, may determine that the optimal ROI 904 corresponding to the at least one missing element is determined as depicted in 902. According to an embodiment, determining the optimal ROI 904 may ensure that the at least one missing element 902 blends seamlessly with the composition of the input image 214. For example, FIG. 10A illustrates an exemplary representation of inserting the at least one missing element (e.g., the flying disc) in the input image 214a (same as the input image 214 as shown in FIG. 9), to generate an output image 1002a of the dog jumping in a park to catch the flying disc. FIG. 10B illustrates exemplary representation of improving visual composition of the input image 214b of a dog jumping high in the air with clouds in the background. The input image 214b may be given to the electronic device 102 to generate an output image 1002b where the dog is jumping in the air to cross a fence, thereby, enhancing the visual composition of the input image 214b.

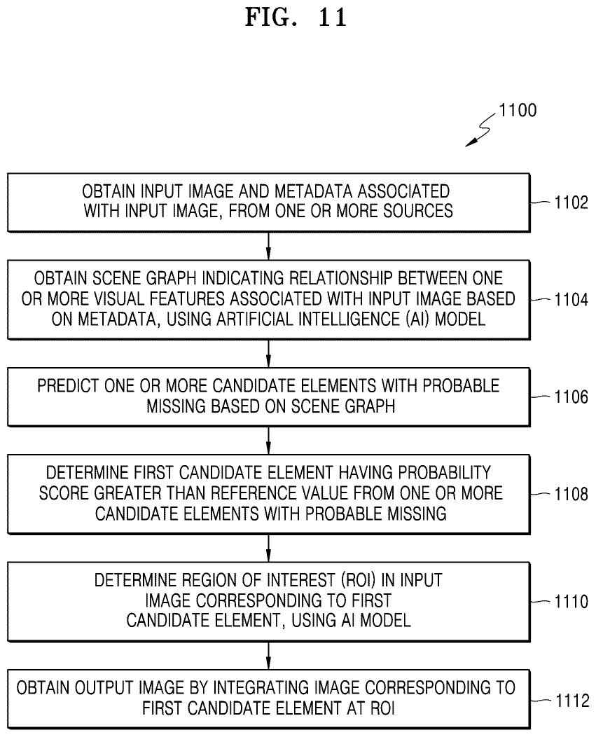

FIG. 11 illustrates a flow chart of a method 1100 of improving visual composition of the image according to an embodiment of the present disclosure.

In operation 1102, the method 1100 may include obtaining the input image 214 and the metadata 215 associated with the input image 214, from one or more sources 104. The one or more sources 104 may include, but is not limited to, an image database, an external camera, a camera associated with the electronic device 102, and the like. According to an embodiment, the input image 214 may be captured by a camera associated with the electronic device 102 in real-time. For example, the input image 214 may be an image of a dog jumping in a park (as depicted in 214a of FIG. 10a). In this example, the metadata may include, but not limited to, sunny and park.

In operation 1104, the method 1100 may include generating the scene graph 302 (as shown in FIG. 3) indicating a relationship between one or more visual features associated with the input image 214 based on the metadata 215, using the AI model 212. In an example, the one or more visual features, may include, but not be limited to, park, dog, jumping, mouth open, grass and trees.

In operation 1106, the method 1100 may include predicting one or more candidate elements (e.g. one or more probable missing elements) based on the scene graph 302. The processor 202 in conjunction with the AI model 212 may predict the one or more candidate elements (e.g. one or more probable missing elements). In an example, based on the input image 214 (e.g., the image of the dog jumping in a park), the one or more visual features and the metadata 215, the AI model 212 may predict that the one or more candidate elements (e.g. one or more probable missing elements) may be, a ball, a flying disc and kids.

In operation 1108, the method 1100 may include determining the first candidate element (e.g. at least one missing element) having a probability score above a reference value, from the one or more candidate probable missing elements. For example, the reference value may be a predefined threshold score. The processor 202 in conjunction with the AI model 212 may assign a probability score to each of the one or more candidate probable missing elements based on a relationship between each of the one or more candidate probable missing elements and the one or more visual features. For example, the probability score corresponding to the ball, the flying disc and the kids may be 0.6, 089 and 0.5, respectively (as shown in FIG. 4). In this example, the reference value may be 0.7, and as such, the AI model 212 may identify the flying disc as the first candidate element. In an embodiment, the AI model 212 based on the segmentation map, and the ROI (e.g. the optimal ROI), may determine a text prompt for generating the image associated with the first candidate element. For example, consider the first candidate element is a flying disc and the ROI is on the segment with trees (refer FIGS. 7 and 9). In this example, as the trees are green, the AI model 212 may determine that the best color for the flying disc is orange. The text prompt “orange” may be considered for generating an orange flying disc.

In operation 1110, the method 1100 may include determining a Region of Interest (ROI) (e.g. an optimal ROI) corresponding to the first candidate element (e.g. at least one missing element). The processor 202 may determine the ROI based on the depth map and the segmentation map of the input image 214. The process of determining the ROI is explained in detail with respect to FIGS. 5-9 and is not explained again for the sake of brevity.

In operation 1112, the method 1100 may include generating an output image by integrating an image corresponding to the first candidate element at the ROI, to improve the visual composition of the input image 214. According to an embodiment, the image corresponding to the first candidate element may be generated by the AI model 212 based on a text prompt indicating characteristics of the at least one missing element. According to an embodiment, different input noise values may be provided to the AI model 212, generating different output images. The different output images may enhance user experience by introducing unpredictability into the output. According to an embodiment, the method 1100 illustrated in FIG. 11 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components)) and executed on a computer (e.g., any suitable computer, such as a laptop computer, net book, Web book, tablet computing device, smart phone, or other mobile computing device). Such software may be executed, for example, on a single local computer.

The sequence of operations of the method 1100 need not be necessarily executed in the same order as they are presented. Further, one or more operations may be grouped together and performed in form of a single step, or one operation may have several sub-steps that may be performed in parallel or in sequential manner.

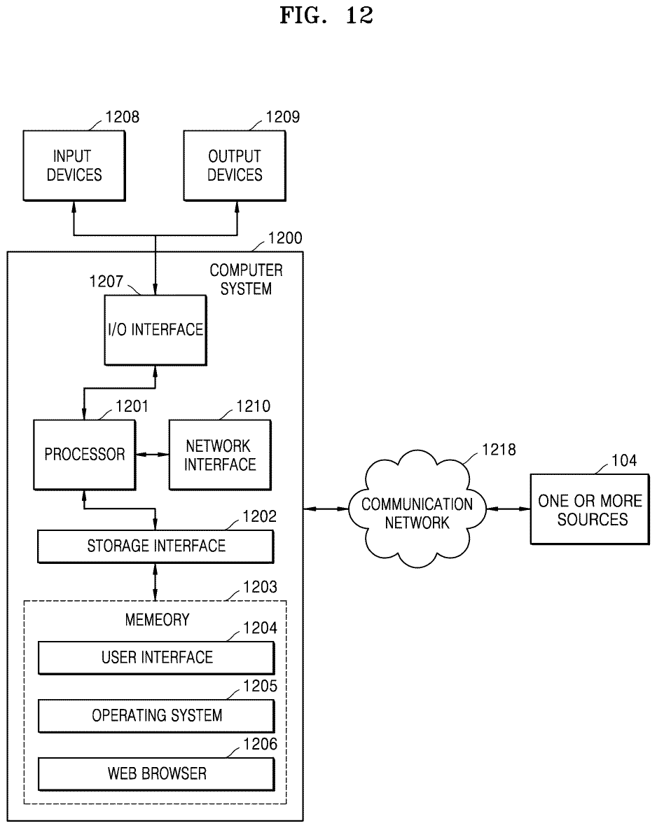

FIG. 12 illustrates a block diagram of an exemplary computer system 1200 for implementing one or more embodiments consistent with the present disclosure. According to an embodiment, the computer system 1200 may be used to implement the electronic device 102. For example, the computer system 1200 may be used for improving visual composition of images. The computer system 1200 may include a processor 1201 (e.g. Central Processing Unit (CPU)). The processor 1201 may include at least one data processor. The processor 1201 may include specialized processing units such as integrated system (bus) controllers, memory management control units, floating point units, graphics processing units, digital signal processing units, etc.

The processor 1201 may be in communication with one or more input/output (I/O) devices via I/O interface 1207. The I/O interface 1207 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.11b/g/n/x, Bluetooth, cellular (e.g., code-division multiple access (CDMA), high-speed packet access (HSPA+), global system for mobile communications (GSM), long-term evolution (LTE), WiMAX, or the like), etc.

The computer system 1200 may communicate with one or more I/O devices using the I/O interface 1207. For example, the input device 1208 may include, but is not limited to, an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 1209 may include, but is not limited to, a printer, fax machine, video display (e.g., cathode ray tube (CRT), liquid crystal display (LCD), light-emitting diode (LED), plasma, plasma display panel (PDP), organic light-emitting diode display (OLED) or the like), audio speaker, etc.

The processor 1201 may be in communication with a communication network 1218 via a network interface 1210. The network interface 1210 may communicate with the communication network 1218. The network interface 1210may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1218 may include, without limitation, a direct interconnection, local area network (LAN), wide area network (WAN), wireless network (e.g., using Wireless Application Protocol), the Internet, etc. The network interface 1210 may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 1218 may include, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc. The communication network 1218 may be in communication with the one or more sources 104 to generate an output image with improved visual composition of the input image.

In some embodiments, the processor 1201 may be in communication with a memory 1203 via a storage interface 1202. The memory 1203 may include, but is not limited to, Random Access Memory (RAM), Read Only Memory (ROM), etc. The storage interface 1202 may connect to memory 1203. The memory may include, but is not limited to, memory drives, removable disc drives, etc., which may employ connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 1203 may store a collection of program or database components, including, without limitation, user interface 1204, an operating system 1205, web browser 1206 etc. In an embodiment, computer system 1200 may store user/application data, such as, the data, variables, records, etc., as described in this disclosure. Such databases may be implemented as fault-tolerant, relational, scalable, secure databases such as Oracle® or Sybase®.

The operating system 1205 may facilitate resource management and operation of the computer system 1200. Examples of operating systems may include, but is not limited to, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In an embodiment, the computer system 1200 may implement the web browser 1206 stored program component. The web browser 1206 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. The web browser 1206 may utilize facilities such as AJAX™, DHTML™, ADOBE® FLASH™, JAVASCRIPT™, JAVA™, Application Programming Interfaces (APIs), etc. In an embodiment, the computer system 1200 may implement a mail server (not shown in Figure) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In an embodiment, the computer system 1200 may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples of the computer-readable medium may include, but is not limited to, RAM, ROM, volatile memory, non-volatile memory, hard drives, Compact Disc Read-Only Memory (CD ROMs), Digital Video Disc (DVDs), flash drives, disks, and any other known physical storage media.

An embodiment of the present disclosure may provide methods and systems of improving visual composition of input images. According to an embodiment of the present disclosure, visual composition may be improved through the placement of semantically coherent elements in the input image. Identifying and placing elements in the input image can greatly enrich the narrative impact of the input image. The output image can function as a connection between different elements in the input image and create relationships that were previously absent. The placement of the additional element may act as a new focal point or subject within the input image thereby drawing the viewer's attention to a specific area. New elements can contribute to the overall mood, atmosphere, or action of the input image, either by complementing or contrasting with other elements in the input image. Moreover, an embodiment of the present disclosure may eliminate manual efforts to edit the input image which can be computationally intensive and time-consuming, while the result may also look unnatural. Therefore, an embodiment of the present disclosure may save time taken to edit the input image while also ensuring the output image looks natural.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the disclosure.

In an example case in which a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

According to an embodiment illustrated in FIG. 11, the operations show certain events occurring in a certain order. However, the disclosure is not limited thereto, and as such, according to an embodiment, certain operations may be performed in a different order, modified, or removed. Moreover, operations or steps may be added to the above-described logic and still conform to the described embodiments. Further, operations described herein may occur sequentially or certain operations may be processed in parallel. Yet further, operations may be performed by a single processing unit or by distributed processing units.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the disclosure is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

In an embodiment of the disclosure, a method may include obtaining, from one or more sources, an input image and metadata associated with the input image. The method may include obtaining, using an Artificial Intelligence (AI) model, a scene graph indicating a relationship between one or more visual features associated with the input image based on the metadata. The method may include predicting, using the AI model, one or more candidate probable missing elements based on the scene graph. The method may include determining a first candidate element having a probability score greater than a reference value, from the one or more candidate probable missing elements. The method may include determining, using the AI model, a region of interest (ROI) in the input image corresponding to the first candidate element. The method may include obtaining an output image by integrating an image corresponding to the first candidate element at the ROI.

In an embodiment of the disclosure, the method may include predicting, using the AI model, one or more candidate probable missing elements based on at least one of the scene graph, the one or more visual features, the input image and the metadata.

In an embodiment of the disclosure, each of the one or more candidate elements may be assigned a corresponding probability score based on a relationship between each of the one or more candidate probable missing elements and the one or more visual features.

In an embodiment of the disclosure, the obtaining the scene graph may comprise determining, by the AI model, contextual information associated with the input image. In an embodiment, the obtaining the scene graph may comprise obtaining, by the AI model, the scene graph based on the contextual information. The contextual information may comprise at least one of the one or more visual features in the input image, visual attributes associated with each of the one or more visual features, and a relationship between the one or more visual features.

In an embodiment of the disclosure, the image corresponding to the first candidate element may be obtained by the AI model based on a text prompt indicating a characteristic of the first candidate element.

In an embodiment of the disclosure, the ROI corresponding to the first candidate element may be identified based on at least one of a depth map and a segmentation map of the input image.

In an embodiment of the disclosure, determining the first candidate element may comprise determining at least one of a color, an action and an orientation corresponding to the first candidate element.

In an embodiment of the disclosure, the AI model may be configured to generate different output images based on different input noise values and the image corresponding to the first candidate element at the ROI.

In an embodiment of the disclosure, an electronic device may include memory configured to store at least one instruction. The electronic device may include at least one processor, wherein, when executed by the at least one processor individually or collectively, the at least one instruction may be configured to control the electronic device to obtain, from one or more sources, an input image and metadata associated with the input image. The at least one instruction may be configured to control the electronic device to obtain, using an Artificial Intelligence (AI) model, a scene graph indicating a relationship between one or more visual features associated with the input image based on the metadata. The at least one instruction may be configured to control the electronic device to predict, using the AI model, one or more candidate probable missing elements based on the scene graph. The at least one instruction may be configured to control the electronic device to determine a first candidate element having a probability score greater than a reference value, from the one or more candidate probable missing elements. The at least one instruction may be configured to control the electronic device to determine, using the AI model, a region of interest (ROI) in the input image corresponding to the first candidate element. The at least one instruction may be configured to control the electronic device to obtain an output image by integrating an image corresponding to the first candidate element at the ROI.

In an embodiment of the disclosure, the at least one instruction may be configured to control the electronic device to predict, using the AI model, one or more candidate probable missing elements based on at least one of the scene graph, the one or more visual features, the input image and the metadata.

In an embodiment of the disclosure, when executed by the at least one processor individually or collectively, the at least one instruction may be configured to control the electronic device to determine, using the AI model, contextual information associated with the input image. In an embodiment, when executed by the at least one processor individually or collectively, the at least one instruction may be configured to control the electronic device to obtain, using the AI model, the scene graph based on the contextual information. The contextual information may comprise at least one of the one or more visual features in the input image, visual attributes associated with each of the one or more visual features, and a relationship between the one or more visual features.

In an embodiment of the disclosure, when executed by the at least one processor individually or collectively, the at least one instruction may be configured to control the electronic device to determine at least one of a color, an action and an orientation corresponding to the first candidate element.

In an embodiment of the disclosure, a non-transitory computer-readable storage medium configured to store at least one instruction, which, when executed by at least one processor individually or collectively, may cause the at least one processor to perform the method.

In an embodiment of the disclosure, a non-transitory computer-readable storage medium configured to store at least one instruction, which, when executed by at least one processor individually or collectively, may cause the at least one processor to obtain, from one or more sources, an input image and metadata associated with the input image. The at least one instruction, which, when executed by at least one processor individually or collectively, may the at least one processor to obtain, using an Artificial Intelligence (AI) model, a scene graph indicating a relationship between one or more visual features associated with the input image based on the metadata. The at least one instruction, which, when executed by at least one processor individually or collectively, may cause the at least one processor to predict, using the AI model, one or more candidate probable missing elements based on the scene graph. The at least one instruction, which, when executed by at least one processor individually or collectively, may cause the at least one processor to determine a first candidate element having a probability score greater than a reference value, from the one or more candidate probable missing elements. The at least one instruction, which, when executed by at least one processor individually or collectively, may cause the at least one processor to determine, using the AI model, a region of interest (ROI) in the input image corresponding to the first candidate element. The at least one instruction, which, when executed by at least one processor individually or collectively, may cause the at least one processor to obtain an output image by integrating an image corresponding to the first candidate element at the ROI.

In an embodiment of the disclosure, the at least one instruction, which, when executed by at least one processor individually or collectively, may cause the at least one processor to predict, using the AI model, one or more candidate probable missing elements based on at least one of the scene graph, the one or more visual features, the input image and the metadata.

In an embodiment of the disclosure, the at least one instruction, which, when executed by at least one processor individually or collectively, may cause the at least one processor to determine, using the AI model, contextual information associated with the input image. The at least one instruction, which, when executed by at least one processor individually or collectively, may cause the at least one processor to obtain, using the AI model, the scene graph based on the contextual information. The contextual information may comprise at least one of the one or more visual features in the input image, visual attributes associated with each of the one or more visual features, and a relationship between the one or more visual features.

In an embodiment of the disclosure, the at least one instruction, which, when executed by at least one processor individually or collectively, may cause the at least one processor to determine at least one of a color, an action and an orientation corresponding to the first candidate element.

What is claimed is:

1. A method performed by an electronic device, comprising:
obtaining, from one or more sources, an input image and metadata associated with the input image;
obtaining, using an Artificial Intelligence (AI) model, a scene graph indicating a relationship between one or more visual features associated with the input image based on the metadata;
predicting, using the AI model, one or more candidate probable missing elements based on the scene graph;
determining a first candidate element having a probability score greater than a reference value, from the one or more candidate probable missing elements;
determining, using the AI model, a region of interest (ROI) in the input image corresponding to the first candidate element; and
obtaining an output image by integrating an image corresponding to the first candidate element at the ROI.

2. The method of claim 1, wherein each of the one or more candidate probable missing elements is assigned a corresponding probability score based on a relationship between each of the one or more candidate probable missing elements and the one or more visual features.

3. The method of claim 1, wherein the obtaining the scene graph comprises:
determining, by the AI model, contextual information associated with the input image, the contextual information comprising at least one of the one or more visual features in the input image, visual attributes associated with each of the one or more visual features, and a relationship between the one or more visual features; and
obtaining, by the AI model, the scene graph based on the contextual information.

4. The method of claim 1, wherein the image corresponding to the first candidate element is obtained by the AI model based on a text prompt indicating a characteristic of the first candidate element.

5. The method of claim 1, wherein the ROI corresponding to the first candidate element is identified based on at least one of a depth map and a segmentation map of the input image.

6. The method of claim 1, wherein determining the first candidate element further comprises:
determining at least one of a color, an action and an orientation corresponding to the first candidate element.

7. The method of claim 1, wherein the AI model is configured to generate different output images based on different input noise values and the image corresponding to the first candidate element at the ROI.

8. An electronic device, comprising:
memory configured to store at least one instruction; and
at least one processor, comprising processing circuitry,
wherein, when executed by the at least one processor individually or collectively, the at least one instruction is configured to control the electronic device to:
obtain, from one or more sources, an input image and metadata associated with the input image;
obtain, using an Artificial Intelligence (AI) model, a scene graph indicating a relationship between one or more visual features associated with the input image based on the metadata;
predict, using the AI model, one or more candidate probable missing elements based on the scene graph;
determine a first candidate element having a probability score greater than a reference value, from the one or more candidate probable missing elements;
determine, using the AI model, a region of interest (ROI) in the input image corresponding to the first candidate element; and
obtain an output image by integrating an image corresponding to the first candidate element at the ROI.

9. The electronic device of claim 8, wherein each of the one or more candidate probable missing elements is assigned a corresponding probability score based on a relationship between each of the one or more candidate probable missing elements and the one or more visual features.

10. The electronic device of claim 8, wherein, when executed by the at least one processor individually or collectively, the at least one instruction is further configured to control the electronic device to:
determine, using the AI model, contextual information associated with the input image, the contextual information comprising at least one of: the one or more visual features in the input image, visual attributes associated with each of the one or more visual features, and a relationship between the one or more visual features; and
obtain, using the AI model, the scene graph based on the contextual information.

11. The electronic device of claim 8, wherein the image corresponding to the first candidate element is obtained by the AI model based on a text prompt indicating a characteristic of the first candidate element.

12. The electronic device of claim 8, wherein the ROI corresponding to the first candidate element is identified based on at least one of a depth map and a segmentation map of the input image.

13. The electronic device of claim 8, wherein, when executed by the at least one processor individually or collectively, the at least one instruction is further configured to control the electronic device to:
determine at least one of a color, an action and an orientation corresponding to the first candidate element.

14. The electronic device of claim 8, wherein the AI model is configured to generate different output images based on different input noise values and the image corresponding to the first candidate element at the ROI.

15. A non-transitory computer-readable storage medium configured to store at least one instruction, which, when executed by at least one processor individually or collectively, cause the at least one processor to perform a method comprising:
obtaining, from one or more sources, an input image and metadata associated with the input image;
obtaining, using an Artificial Intelligence (AI) model, a scene graph indicating a relationship between one or more visual features associated with the input image based on the metadata;
predicting, using the AI model, one or more candidate probable missing elements based on the scene graph;
determining a first candidate element having a probability score greater than a reference value, from the one or more candidate probable missing elements;
determining, using the AI model, a region of interest (ROI) in the input image corresponding to the first candidate element; and
obtaining an output image by integrating an image corresponding to the first candidate element at the ROI.

16. The non-transitory computer-readable storage medium of claim 15, wherein each of the one or more candidate elements is assigned a corresponding probability score based on a relationship between each of the one or more candidate probable missing elements and the one or more visual features.

17. The non-transitory computer-readable storage medium of claim 15, wherein the obtaining the scene graph comprises:
determining, by the AI model, contextual information associated with the input image, the contextual information comprising at least one of the one or more visual features in the input image, visual attributes associated with each of the one or more visual features, and a relationship between the one or more visual features; and
obtaining, by the AI model, the scene graph based on the contextual information.

18. The non-transitory computer-readable storage medium of claim 15, wherein the image corresponding to the first candidate element is obtained by the AI model based on a text prompt indicating a characteristic of the first candidate element.

19. The non-transitory computer-readable storage medium of claim 15, wherein the ROI corresponding to the first candidate element is identified based on at least one of a depth map and a segmentation map of the input image.

20. The non-transitory computer-readable storage medium of claim 15, wherein the at least one instruction, which, when executed by the at least one processor individually or collectively, further cause the at least one processor to:
determine at least one of a color, an action and an orientation corresponding to the first candidate element.
